(19) United States
(12) Patent Application Publication
(10) Pub. No.: US 2008/0150739 A1
(43) Pub. Date: Jun. 26, 2008

(54) Medical gas cylinder alarm and monitoring system and method

(76) Inventor: Stephan C.F. Gamard, Kenmore, NY (US)

Correspondence Address: PRAXAIR, INC.;LAW DEPARTMENT - M1 557, 39 OLD RIDGEBURY ROAD, DANBURY, CT, 06810-5113, US

(21) Appl. No.: 11/645,396

(22) Filed: Dec. 26, 2006

(51) Int. Cl. G08B 21/00

(52) U.S. Cl. 340/626

(57) ABSTRACT

A medical gas cylinder monitoring and alarm device is provided. The medical gas cylinder monitoring and alarm device is a portable device that provides a monitoring function for one or more cylinders and may be carried by a patient or respiratory therapist or may be removably affixed to a medical gas cylinder. The monitoring device is a processor based device adapted to receive selected user inputs for a specific medical gas cylinder application and determine the estimated time remaining before the medical gas cylinder is emptied. The device displays the time remaining for the medical gas cylinder and is also adapted to provide visual and audible alarm notifications when the gas cylinder is near empty.

### CROSS REFERENCE TO RELATED APPLICATIONS

None

### BACKGROUND

Medical gas cylinders are widely used in home care applications as well as hospital settings for dispensing of medical gases such as oxygen, heliox, nitrogen, nitrous oxide, etc. While medical gas cylinders often include visible pressure gauges to generally indicate whether the cylinder is full, partially full, or empty, such pressure gauges do not provide an indication of the duration until the medical gas cylinder will empty. Respiratory therapists and other medical personnel or users have previously used cylinder duration charts and tables to estimate probable duration of the gas cylinder at a given flow rate but such manual charts and tables are typically not very convenient and do not provide a continuous monitoring of the medical gas cylinders or any warning that the cylinder is near empty.

Thus, there is a need for an improved yet simple means to monitor medical gas cylinders that allows a user to precisely and continuously monitor the cylinder duration for the specific flow rate and that provides adequate warning when the medical gas cylinder is near empty.

### SUMMARY OF THE INVENTION

In one aspect the invention may be characterized as a medical gas cylinder monitoring and alarm device comprising: a portable housing adapted to be removably affixed to a medical gas cylinder; a user interface coupled to the housing and adapted to receive selected user inputs; an output disposed within the housing and adapted to provide an alarm notification; and a processor disposed within the housing and operatively coupled to the user interface and the output, the processor adapted to ascertain the remaining duration until the pressure in the medical gas cylinder reaches a prescribed pressure threshold value based on the user inputs and provide a signal to the output when remaining duration reaches an alarm threshold.

The invention may also be characterized as a method of monitoring a medical gas cylinder comprising the steps of: inputting selected user inputs including some or all of the followings: gas cylinder size, gas cylinder pressure, type of gas, and flow rate to a processor based portable monitoring device; calculating a duration remaining until the pressure within the medical gas cylinder reaches a prescribed pressure threshold value based on the selected user inputs; setting an alarm threshold; and displaying the duration remaining until the pressure within the medical gas cylinder reaches the prescribed pressure threshold value on an output display of the processor-based portable monitoring device.

### BRIEF DESCRIPTION OF THE DRAWINGS

While the specification concludes with claim distinctly pointing out the subject matter that applicants regard as their invention, it is believed that the invention will be better understood when taken in connection with accompanying drawings in which:

FIG. 1 illustrates a perspective view of an embodiment of the portable gas cylinder alarm and monitoring device in accordance with the present invention and with the output displaying the medical gas cylinder status information;

FIG. 2 illustrates the portable gas cylinder alarm and monitoring device of FIG. 1 with the output displaying an alarm notification; and

FIG. 3 illustrates a perspective view of another embodiment of the portable gas cylinder alarm and monitoring device in accordance with the present invention.

### DETAILED DESCRIPTION

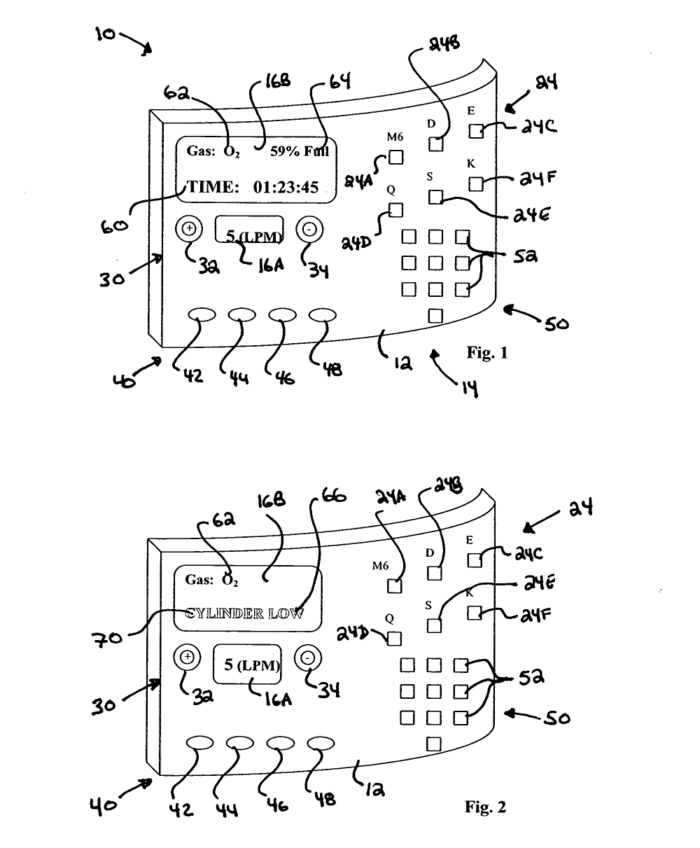

Turning now to FIG. 1, there is shown an embodiment of the present gas cylinder alarm and monitoring device 10. The monitoring device 10 includes a portable housing 12 adapted to be removably affixed to a medical gas cylinder (not shown); a user interface 14 adapted to receive selected user inputs; an output display 16A/16B, an internally disposed processor, and an internally disposed audible alarm (not shown). The illustrated housing 12 preferably is a curved or flexible structure that is adapted to conform to the outside of the medical gas cylinder. Alternatively, the housing design can be of any ergonomic or aesthetic configuration useful in marketing of medical gas and associate equipment.

In the illustrated embodiment, the user interface 14 is sectioned into a plurality of sections with a first section 24 dedicated to user selection of the medical gas cylinder size in the form of key 24 entry. The user selects the type or size of the medical gas cylinder to be monitored by pressing the corresponding key (24A, 24B, 24C. 24D, 24E, and 24F). Each type of medical gas cylinder is associated with a known preset volume of gas (when full) based on typical average values, as identified in Table 1.

TABLE 1
Cylinder Size and Gas Volume

| | Cylinder Size | | | | | |
|---|---|---|---|---|---|---|
| | M6 | D | E | Q | S | K |
| Oxygen Volume (Liters) | 165 | 425 | 708 | 2350 | 4361 | 7051 |

The above-identified cylinder contents are average volumes based on the pressure of the medical gas when the gas cylinder is filled. These values can fluctuate due to changes in temperature, filling procedures or operators. To that end, a safety factor should be incorporated in the processor (not shown) of the monitoring device 10 that reduces the preset volume for each of the above-identified gas cylinders to ensure that there is sufficient medical gas even when the monitoring device 10 indicates the gas cylinder is empty. A commonly accepted safety factor in the medical gas industry is to consider the gas cylinder empty when the gas pressure within the cylinder reaches 500 psig compared to a gas pressure within the cylinder of about 2,200 psig when the gas cylinder is full.

The second section 30 allows the user to select the medical gas flow rate of the medical gas cylinder that is to be monitored. This second section 30 of the user interface 14 includes a key labeled “+” 32 to increase the indicated flow rate and a key labeled “−” 34 to decrease the indicated flow rate or pressure. The output display 16A provides a numerical value corresponding to the indicated flow rate or pressure, as adjusted by the user. Alternatively, the second section 30 could include a plurality of preset flow rate values or pre-set pressures associated with individual keys or could include a small keypad adapted to allow for manual entry of the indicated flow rate or pressure.

The third section 40 of the user interface 14 is the alarm or monitoring section. This third section 40 includes a plurality of user keys, including a user key for ‘Timer/Alarm Set’ 42; a user key for ‘Alarm Silence’ 44; a user key for ‘Timer/Alarm On’ 46; and a user key for ‘Timer/Alarm Off’ 48. The ‘Alarm Set’ key 42 allows the user to set or initiate the alarm and timing function by prompting the user to input selected data such as selected flowrate, cylinder size, cylinder gas, cylinder pressure, cylinder content, etc. The ‘Alarm Silence’ key 44 is adapted to allow the user to silence the audible alarm within the monitoring device 10. The ‘Timer/Alarm On’ key 46 allows the user to start or continue the timing function performed by the processor to ascertain the estimated time remaining before the gas cylinder is emptied. The ‘Timer/Alarm Off’ key 48 is adapted to allow the user to terminate, pause or temporarily suspend the timing and alarm functions of the processor within the monitoring device 10 such that the user can edit the data, adjust the paramenters or turn off the flow of medical gas. As would be apparent to those skilled in the art, the processor within the monitoring device 10 is adapted to ascertain the estimated time remaining before the gas cylinder is emptied with the following algorithm:

$$Time remaining = \frac{gas volume}{flowrate} ;$$

where the gas volume in liters is estimated from by user inputs of the cylinder size together with the cylinder pressure or cylinder content; and the flowrate in liters per minute is obtained from user input of the selected flowrate. Additional provision is made within the processor to accommodate for a potential change in flow rate by the user while the medical gas cylinder is being used, since the processor keeps track of the cylinder estimated internal volume.

The fourth section 50 of the user interface 14 allows for identification of other information or data pertinent to the medical gas cylinder monitoring function. For example, identification of the medical gas within the cylinder to be monitored (e.g. oxygen, heliox, nitric oxide, nitrous oxide, medical air, etc.), the cylinder pressure, cylinder content, patient identification. Also, where gas blends are used, the additional data could also include gas concentrations (e.g. 80/20 Heliox, 70/30 Heliox, etc). As illustrated, this fourth section 50 of the user interface 14 is preferably a standard numerical or alpha-numerical keypad 52 that allows the user to input the selected information when prompted. Such prompts may be presented to the user on the output display 16B.

The output display 16A/16B in the illustrated embodiment comprises two sections, including a main display 16B and a cylinder flowrate display 16A. The main display 16B is preferably used both as a user prompt display for user inputs as well as a cylinder status display. When used as a user prompt display, the liquid crystal display will prompt or instruct the user to input selected data and information including for example, the identification of the medical gas within the cylinder to be monitored (e.g. oxygen, heliox, etc.), the cylinder size, flowrate, cylinder pressure, cylinder content, patient identification, etc. As described above, the user inputs the data via the user interface 14. When used as a cylinder status display, the main display 16B will visually indicate information representing: the time remaining before the cylinder is emptied in hours-minutes-seconds 60, the selected medical gas 62; and an estimate percentage of the medical gas remaining within the gas cylinder 64. Additional information in the form of alpha-numerical text or icons may also be included on the output display.

Turning now to FIG. 2, the embodiment of the present gas cylinder alarm and monitoring device 10 is shown with the main display 16B indicating an alarm status 70. The alarm status 70 is displayed when the time remaining before the gas cylinder is emptied equals a prescribed alarm threshold (e.g. 5 minutes before the gas cylinder is emptied). When the time remaining before the gas cylinder is emptied reaches the alarm threshold, the processor within the monitoring device 10 activates the alarm status 70 as well as the audible alarm. In the preferred embodiment, the user can stop the alarm, hence acknowledging it, by pressing the Alarm Silence key 44. If the user does not wish an alarm reminder, pressing the Timer/Alarm Off key 46 at anytime during the countdown to deactivate the alarms.

As seen in FIG. 2, the main display 16B presents a visual alarm message 66 or indicator to notify the user or the patient that the gas content within the cylinder is low and the medical gas cylinder should be replaced soon. Although not shown, the alarm message 66 may also be presented in a flashing sequence or using alternate colors for the message or background. In addition to the alarm message 66, the main display 16B may also present additional information including the estimated time remaining before the cylinder is actually emptied, the selected medical gas 62; etc.

Attachment of the cylinder monitoring device 10 to the medical gas cylinder can be accomplished in many ways. Preferably, the monitoring device is removably affixed to the medical gas cylinder using commercially available adhesives or other attachment means such as hook and loop means (i.e. Velcro™). Where steel cylinders are used, the monitoring device can be removably affixed to the medical gas cylinder using magnet strips. Alternatively, the monitoring device can be tied or secured to the medical gas cylinder using an elastic band, or a strap, clip, lanyard, or other tethering means. Alternatively, the user can simply carry the cylinder monitoring device with them.

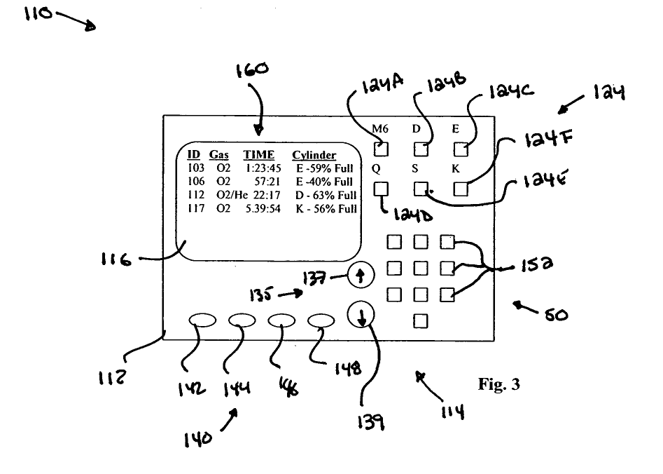

Turning now to FIG. 3, there is shown an alternate embodiment of the present medical gas cylinder alarm and monitoring device that is adapted to monitor multiple medical gas cylinders. The monitoring device 110 includes a portable housing 112 adapted to be removably affixed to a medical gas cylinder; a user interface 114 adapted to receive selected user inputs; an output display, an internally disposed processor, and an internally disposed audible alarm. It will be appreciated that many of the elements and features of this embodiment are the same or similar to the elements and features of the previously described embodiment and for the sake of clarity, will not be repeated here in great detail.

The primary difference between the two preferred embodiments is that the embodiment of FIG. 3 is adapted for use by a respiratory therapist or other trained medical personnel who may need to monitor multiple medical gas cylinders concurrently and who often is not always near or proximate the gas cylinders to be monitored. This embodiment allows the user to monitor multiple gas cylinders and provides an output display 116 that shows the alarm and monitoring status 160 of the multiple gas cylinders. The user is prompted to input the information for each patient and gas cylinder to be monitored using the appropriate user interface 114 and can scroll through the data presented on the output display 116 for each patient as needed to start, edit or end a monitoring session.

As with the above-described embodiment, the user interface 114 is sectioned into a plurality of sections with a first section 124 dedicated to user selection of the medical gas cylinder size in the form of key 124 entry. The user selects the medical gas cylinder to be monitored by pressing the key (124A, 124B, 124C, 124D, 124E, and 124F) corresponding to the cylinder size and type. The second section 135 includes an “up arrow” key 137 and a “down arrow” key 139 that allows the user to scroll through the output display 116 for purposes of inputting or editing the salient information as well as starting, silencing or and ending the alarm and timing function for each gas cylinder monitored.

The third section 140 of the user interface 114 is the alarm or monitoring section. This third section 140 includes a plurality of user keys, including a user key for ‘Timer/Alarm Set’ 142; a user key for ‘Alarm Silence’ 144; a user key for ‘Timer/Alarm On’ 146; and a user key for ‘Timer/Alarm Off’ 148 whose functions are similar to the functions described with reference to FIGS. 1 and 2 and are used for each of the patients and gas cylinders that are monitored.

The fourth section 150 of the user interface 114 is a standard numerical or alpha-numerical keypad 152 that allows the user to input selected information or data pertinent to the medical gas cylinder monitoring function including patient identification, location, selected flowrate, gas identification, cylinder pressure, cylinder content, etc.

As the monitoring device 110 illustrated in FIG. 3 is adapted to concurrently monitor multiple gas cylinders, the device is preferably a pocket-size or hand held device that is carried by the respiratory therapist or medical personnel.

Additional features of the present monitoring device could include integrated flowmeters, pressure sensors or other form of direct measurement with the gas cylinders to be monitored to automate the data collection. In addition, various data communication features or means such as a locator/identification means, a WiFi or RFID chip could be employed for improved data collection. In both embodiments, the power source of the monitoring device is preferably a small battery similar to ones used in portable calculators or light-powered cells, or a combination thereof.

The present medical gas cylinder monitoring and alarm system and method provides a simple yet effective means for continuously monitoring one or more medical gas cylinders and providing appropriate alarm notifications when the cylinder is near empty. While the present invention has been described with reference to one or more preferred embodiments, numerous changes, additions and modifications may be made without departing from the spirit and scope of the present invention, as defined by the appended claims.

What is claimed is:

1. A medical gas cylinder alarm and monitoring device comprising:
a portable housing adapted to be removably affixed to a medical gas cylinder;
a user interface coupled to the housing and adapted to receive selected user inputs;
an output disposed within the housing and adapted to provide an alarm notification; and
a processor disposed within the housing and operatively coupled to the user interface and the output, the processor adapted to ascertain the remaining duration until the pressure in the medical gas cylinder reaches a prescribed pressure threshold value based on the user inputs and provide a signal to the output when remaining duration reaches an alarm threshold.

2. The device of claim 1 wherein the output further comprises a visual display.

3. The device of claim 2 wherein the output further comprises an audible alarm.

4. The device of claim 2 wherein the output is further adapted to display the duration remaining until the gas cylinder pressure reaches the prescribed pressure threshold.

5. The device of claim 1 wherein the selected user inputs include gas cylinder size, gas cylinder pressure, and flow rate.

6. The device of claim 1 wherein the prescribed threshold value is 500 psig.

7. The device of claim 1 wherein the housing is magnetically affixed to the medical gas cylinder.

8. The device of claim 1 wherein the housing is affixed to the medical gas cylinder with a hook and loop attachment mechanism.

9. The device of claim 1 wherein the housing is attached to the medical gas cylinder with a strap.

10. A gas cylinder alarm and monitoring device comprising:
a portable housing;
a user interface coupled to the housing and adapted to receive selected user inputs;
a processor disposed within the housing and operatively coupled to the user interface, the processor adapted to ascertain a remaining duration until a medical gas cylinder is near empty and an alarm threshold value based on the user inputs and produce an alarm command when the remaining duration reaches the alarm threshold; and
an output display operatively coupled to the processor and adapted to visually display the remaining duration and display an alarm notification in response to the alarm command from the processor.

11. The device of claim 10 wherein the selected user inputs include gas cylinder size, gas cylinder content, and flow rate.

12. The device of claim 10 wherein the device further comprises an audible alarm operatively coupled to the processor and adapted to provide an audible alarm warning in response to the alarm command from the processor.

13. The device of claim 10 wherein the device is further adapted to monitor a plurality of medical gas cylinders and the selected user inputs for each medical gas cylinder include gas cylinder size, gas cylinder contents, flow rate, and patient identification.

14. The device of claim 13 wherein the output display is further adapted to display for each medical gas cylinder the duration remaining until the medical gas cylinder is near empty.

15. The device of claim 13 wherein the output display is further adapted to display for each medical gas cylinder the duration remaining until the medical gas cylinder is near empty.

15. A method of monitoring a medical gas cylinder comprising the steps of:
inputting selected user inputs including gas cylinder size, gas cylinder content, and flow rate to a processor based portable monitoring device;
calculating a duration remaining until the medical gas cylinder is near empty based on the selected user inputs;
setting an alarm threshold; and
displaying the duration remaining until the medical gas cylinder is near empty on an output display of the processor-based portable monitoring device; and
providing an alarm notification when the duration remaining reaches the alarm threshold value.

16. The method of claim 15 further comprising the step of affixing the processor based portable monitoring device to the medical gas cylinder.

17. The method of claim 15 wherein the alarm notification further comprises an audible alarm.

18. The method of claim 15 wherein the alarm notification further comprises a visual alarm

19. The method of claim 15 wherein the processor based portable monitoring device is further adapted to monitor a plurality of medical gas cylinders and the steps further comprise:
inputting selected user inputs including gas cylinder size, gas cylinder pressure, flow rate and patient identification for each medical gas cylinder to the processor based portable monitoring device;
calculating the duration remaining for each medical gas cylinder;
setting the alarm threshold for each medical gas cylinder; and
displaying the duration remaining for each medical gas cylinder on the output display of the processor-based portable monitoring device.
